(19) United States
(12) Patent Application Publication
(10) Pub. No.: US 2016/0098033 A1
(43) Pub. Date: Apr. 7, 2016

(54) SEMANTIC MANUFACTURING

(71) Applicant: General Electric Company, Schenectady, NY (US)

(72) Inventors: Baljit Singh, Schenectady, NY (US); Abha Moitra, Scotia, NY (US); Michael Evans Graham, Slingerlands, NY (US); Dean Michael Robinson, Niskayuna, NY (US); Tao Jia, Niskayuna, NY (US)

(21) Appl. No.: 14/507,195

(22) Filed: Oct. 6, 2014

(51) Int. Cl. G05B 19/4097

(52) U.S. Cl. CPC G05B 19/4097; G05B 2219/35134

(57) ABSTRACT

A dataset including boundary representations of shapes associated with an item being designed for manufacture is accessed by a semantic processing module. A semantic graph of each of the boundary representations of shapes is generated and a numerical processing module computes geometric attributes of each of the shapes. The semantic graph of a shape is updated based on any geometric attributes computed for the shape. The semantic graphs are then compared to a repository of semantic graphs of manufacturing features to identify instances of manufacturing features. Geometric attributes associated with each instance of a manufacturing feature are then computed. For each instance, the associated geometric attributes are compared against a repository of semantic manufacturing rules to determine whether the instance is in compliance with the rules. A user designing the item is alerted to the presence of any instances of manufacturing features that are not in compliance with the rules.

### TECHNICAL FIELD

This document relates generally to data analysis and visualization. More particularly, but not by way of limitation, to systems and methods for automatically identifying manufacturing features in computer aided design (CAD) dataset and comparing the identified features against a set of semantic manufacturing rules.

### BACKGROUND

When designing an item to be manufactured, a designer may focus on the performance characteristics of the item; the manufacturing of such an item may be a secondary issue. However, when a manufacturing analysis is later performed for the designed item, it may be discovered that the processes required to manufacture the item are too expensive and/or too time consuming. A first option may include the designer updating the item design to improve its characteristics of manufacturability, leading to more design iterations. A second option may include the manufacturer choosing not to follow the design because of the expense or other manufacturing difficulty. The impact of the first option may include added cost and/or delays in the design cycle. The impact of the second option may include a break in the link between design and manufacturing which may result in performance issues if the manufacturer is not careful.

### BRIEF DESCRIPTION OF THE DRAWINGS

Some embodiments are illustrated by way of example and not limitation in the figures of the accompanying drawings in which:

FIG. 1A illustrates an instance of a manufacturing feature being flagged at the design stage for not complying with a set of semantic manufacturing rules.

FIG. 1B illustrates an example pop-up window for allowing designers to consider manufacturing concerns during the design process.

FIG. 2 includes an illustration of a boundary representation and tables containing the topological relationships between the bodies, faces, edges and vertices of the boundary representation.

FIG. 3 illustrates an example semantic graph of the boundary representation.

FIG. 4 is a block diagram illustrating a hardware environment and data flow for identifying instances of manufacturing features.

FIG. 5 is a flowchart illustrating a method, according to an example embodiment, for identifying instances of manufacturing features.

FIG. 6 is a flowchart illustrating a method, according to an example embodiment, for comparing instances of manufacturing features to a set of semantic manufacturing rules.

FIG. 7 is a diagrammatic representation of a machine in the example form of a computer system within which a set of instructions for causing the machine to perform any one or more of the methodologies discussed herein may be executed.

### DETAILED DESCRIPTION

Example systems and methods are described for determining the manufacturability of three-dimensional computer-aided designs (CAD) by recognizing manufacturing features (e.g., a specific geometric shape) based on comparing a semantic graph of the three-dimensional design against a repository of semantic graphs of manufacturing features. A semantic graph, also known as a relational data graph, is a graph that uses links between data points to represent the relationships between the data points. A semantic graph may illustrate relationships as typed links between a pair of typed nodes, wherein the type of link is based on the nature of the relationship and the type of node is based on the nature of the data point. The node and link types may be related through a specified ontology (also known as a schema) and each node may have a set of attributes associated with it (e.g., “length” may be an attribute of a node of type “edge”). In an example embodiment, geometric attributes of the recognized manufacturing features may be analyzed (e.g., compared) with respect to a repository of semantic manufacturing rules. In an example embodiment, the semantic manufacturing rules are described in a language that is formal yet similar to English-like natural language, thereby making it easier for subject matter experts (SMEs) to understand, critique and even modify the rules without the need of a programming background. The technical effect of the example systems and methods may be to provide a user interface for designers of an item for manufacture to review any instances of manufacturing features (recognized in the design of the item) in order to determine whether any of the recognized instances is not compliance with the semantic manufacturing rules.

### Example Design Process

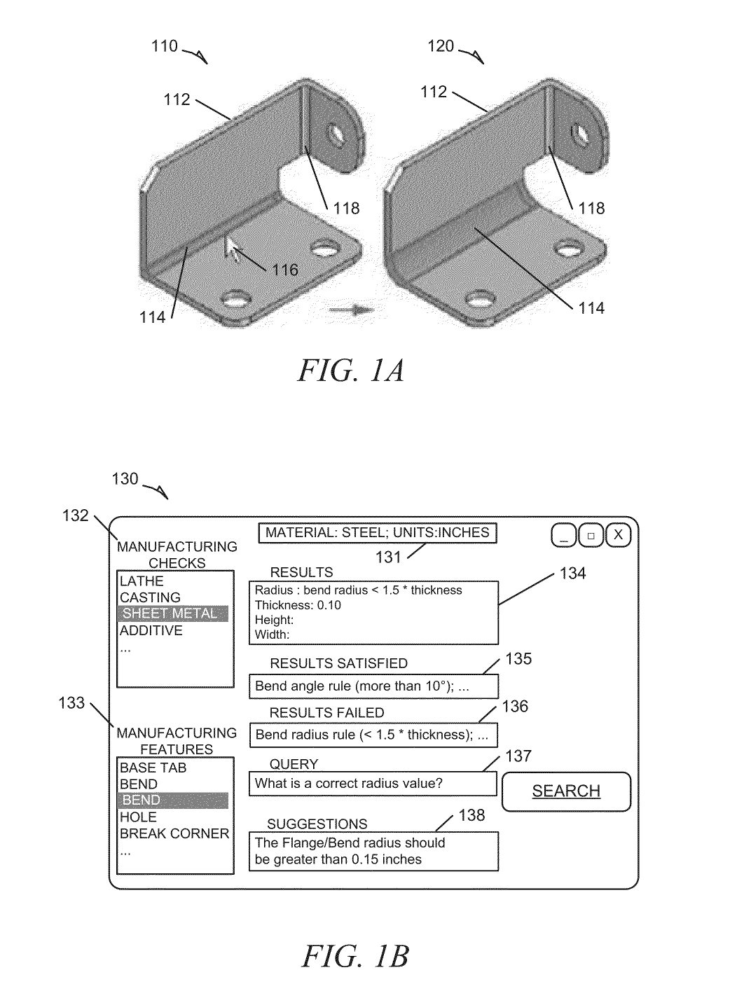

FIG. 1A illustrates an instance of a manufacturing feature being flagged at the design stage for not complying with a set of semantic manufacturing rules and includes an image 110 of an example item 112 being designed using a CAD application. In the given example, the item 112 is to be manufactured from a section of sheet metal, e.g., metal formed by an industrial process into thin, flat pieces. As shown in image 110, the design of the item 112 requires a bend 114 in the sheet metal to provide an approximately 90° angle. The bend 114 is highlighted at 116 by the CAD application so as to warn a designer about any potential problems or challenges with the manufacturing characteristics of the proposed design for the item 112. The bend 116 may then be altered by the designer in view of the concerns regarding the manufacturability of the proposed design for the item. For example, the proposed item design may modified in view of an excessively high cost to manufacture the item because expensive machinery may be required to produce a bend with the originally designed characteristics.

FIG. 1B illustrates an example pop-up window including a user interface for allowing designers to consider manufacturing concerns during the design process. The pop-up window 130 may be used in conjunction with a CAD application to help designers recognize manufacturing concerns. In an example embodiment, the process for triggering the pop-up window 130 may include identifying instances of manufacturing features of the designed item 112, such as “hole”, “corner”, “bend”, etc. Geometric attributes of the manufacturing features of the designed item 112 may then be computed and compared to a set of semantic manufacturing rules for a type of item corresponding to the item 112, e.g., sheet metal. In the example, pop-up window 130 includes a field 131 displaying that the item 112 is to be made of the material: “Steel” and the units of measurement used in the design of item 112 are “Inches”. In the example, pop-up window 130 includes a “Manufacturing Checks” field 132 that lists each type of manufacturing check that may be performed for an item of the same type as the designed the item 112 of the image 110. For example, the manufacturing check for “Sheet Metal” appears highlighted in the list because item 112, in the CAD design of image 110, is a sheet metal item. In the example, pop-up window 130 also includes a “Manufacturing Features” field 133 that lists each instance of a manufacturing feature determined to be present in the designed the item 112 of the image 110. For example, the manufacturing feature “Bend” appears twice in the list because there are two instances of a bend in the CAD design of image 110, e.g., 114 and 118. In the example, pop-up window 130 also includes several fields for displaying manufacturability information to a designer regarding the instances of manufacturing (or assembly) features identified in the design for item 112, as shown in image 110. In the example, the pop-up window 130 includes a “Results” field 134 that is displaying the results of comparing the instance of a “Bend” highlighted in the “Manufacturing Features” field 133 (which corresponds to bend 114) to a set of semantic rules for manufacturing sheet metal items made of steel, e.g., items of the same type as designed item 112.

In the example pop-up window 130, the “Results” field 134 is displaying the results of comparing the bend 114 of item 112 of image 110 to a “bend radius” rule that suggests a bend radius of less than 1.5 times the thickness of the steel sheet metal being bent. As can be seen in the “Results” field 134 of pop-up window 130, the selected instance of a “Bend” feature does not comply with the “bend radius” rule and the result is clearly displayed in a “Results Failed” field 136. In this example, “Results Failed” field 136 indicates that the failure results from the designed bend 114 including a bend radius that is less than 1.5 times the 0.10 inch thickness of the steel sheet metal item of image 110. In the example of pop-up window 130, since the manufacturing rules are semantic rules, a designer may query the semantic manufacturing rules via a “Design Query” field 137 for the correct radius size for bend 114 of the designed item 112 of image 110. In the example of pop-up window 130, a “Search” button may be used to trigger the query and the results of the query may be displayed to a designer via a “Suggestions” field 138. In the example of pop-up window 130, the “Suggestions” field 138 is displaying to a designer that, for a steel sheet metal object with a thickness of 0.10 inches (e.g., like item 112), the correct radius size is 0.15 inches.

In the example, pop-up window 130 also includes a “Rules Satisfied” field 135 that a designer may browse to learn about the semantic manufacturing rules that the designed item 112 does comply with; for example, the design of item 112 is shown to comply with a “Bend angle rule” that suggests an angle of more than 10° for a bend since too small of an angle may be difficult to manufacture.

In the example of FIG. 1A, an image 120 shows the item 112, that was shown being designed using a CAD application in image 110, as it has been modified by a designer (e.g., using the same CAD application) in view of the “Sheet Metal Check” performed via pop-up window 130. In the example of image 120, the bend 114 in the sheet metal that was highlighted in image 110 has been modified so that the bend 114 is more gradual than in the previous design, resulting in a bend 114 that is in compliance with the bend radius rule. The newly designed bend 114 may now be subjected to a similar sheet metal check to show that it is in compliance with the semantic manufacturing rules for bends in a steel sheet metal item.

In example embodiments, the term boundary representation (BREP) may refer to a method for representing shapes via their limits or bounds. A solid is represented as a collection of connected surface elements, the boundary between a solid object and non-solid surroundings. Boundary representation models may be composed of two parts: topology (bodies, faces, edges and vertices) and geometry (surfaces, curves and points). The topology contains information on the relationship between the topological elements, e.g., how the bodies, faces, edges and vertices are connected together. The geometric information may include numerical information regarding a shape, e.g., respective angles or aspect ratio information.

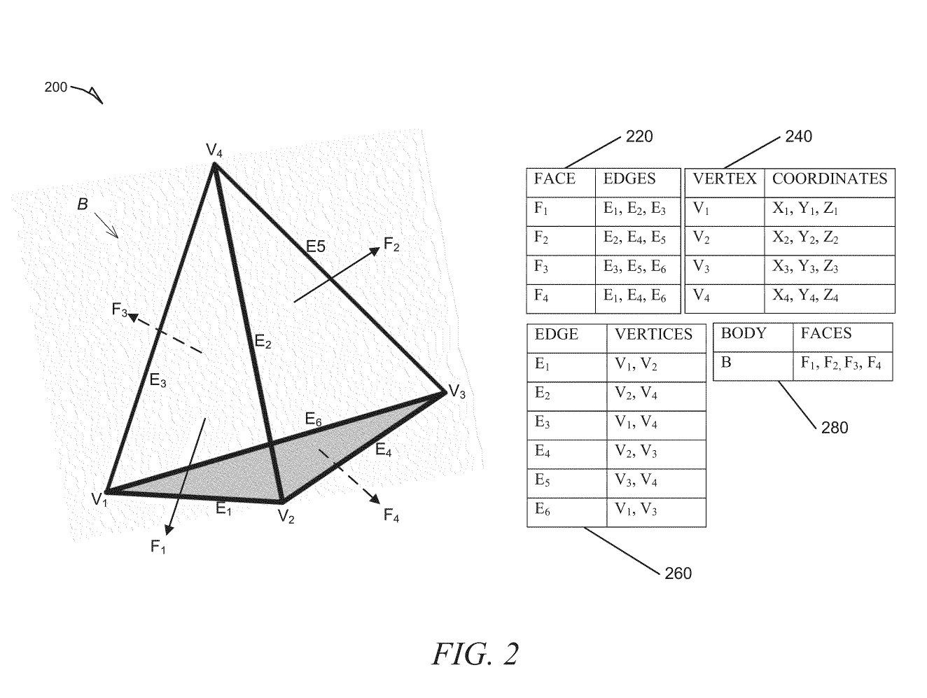

FIG. 2 includes an illustration of a boundary representation and tables containing the topological relationships between the bodies, faces, edges and vertices of the boundary representation. In example embodiments, the following terms, as illustrated in FIG. 2, may include the meanings as shown below.

Vertices (V₁-V₄)—A boundary of an edge. A vertex may correspond to a point in 3D space.

Edge (E₁-E₆)—A connected portion of a curve bounded by vertices. An edge may correspond to a curve in 3D space.

Face (F₁-F₄)—A connected portion of a surface bounded by a set of loops. A face may correspond to a surface in 3D space.

Body (B)—A closed portion of the 3D space bounded by a set of connected faces.

### Example Feature Recognition

FIG. 2 includes an example BREP model 200 and associated data tables (220, 240, 260, 280) for the body, faces, edges and vertices of the BREP model 200 that may be analyzed and processed by a semantic processor 406 in accordance with the systems and methods presented herein. The relationships between the topological elements of BREP model 200 are stored in the tables 220, 240, 260 and 280. For example, face F₁ of BREP model 200 has corresponding edges E₁, E₂, and E₃. The table 240 illustrates geometric information regarding each vertex (V₁-V₄) of BREP model 200: corresponding (x, y and z axis) numerical coordinates.

A manufacturing feature may be described as a set of BREP elements that has a special meaning to an end user designing an item for manufacture. It is usually a subset of the BREP of a body, or a sub-BREP. In an example, feature rules are rules describing this sub-BREP. In an example, a triangle manufacturing feature may be recognized by a triangle rule as follows: Triangle is a class, described by three edges with the full set of associated vertices of the three edges contains three vertices (e.g., the cardinality of the full set of associated vertices is three). Features may also have geometric attributes, for example the triangle feature includes a numerical value for “height”, as the height (e.g., geometric attribute) of the triangle and it also has three geometric attributes of “interior angle”. These geometric attributes of the recognized manufacturing features may not be imported from the numerical (e.g., geometric) data of the BREP because the manufacturing features are not part of the BREP and therefore the numerical data of the BREP may not directly relate to any geometric attribute of the manufacturing features. Therefore, geometric attributes of the manufacturing features may be computed, based on the numerical data of the BREP.

As may be derived based on table 220, each of the faces (F₁-F₄) of BREP model 200 corresponds to an identified instance of the triangle feature because each set of three vertices corresponding to each of the faces has an associated set of vertices that only includes three vertices. For example:

F₁→(E₁, E₂, E₃)→(V₁, V₂, V₄);

F₂→(E₂, E₄, E₅)→(V₂, V₃, V₄);

F₃→(E₃, E₅, E₆)→(V₁, V₃, V₄); and

F₄→(E₁, E₄, E₆)→(V₁, V₂, V₃).

In an example, the topology of a BREP of a shape may be converted into an ontological instance of a semantically described boundary representation of the shape, e.g., a semantic graph. A numerical processor may then compute various geometric attributes of the shape represented by the boundary representation and enhance the corresponding semantic graph of the boundary representation based on this additional geometric attribute information.

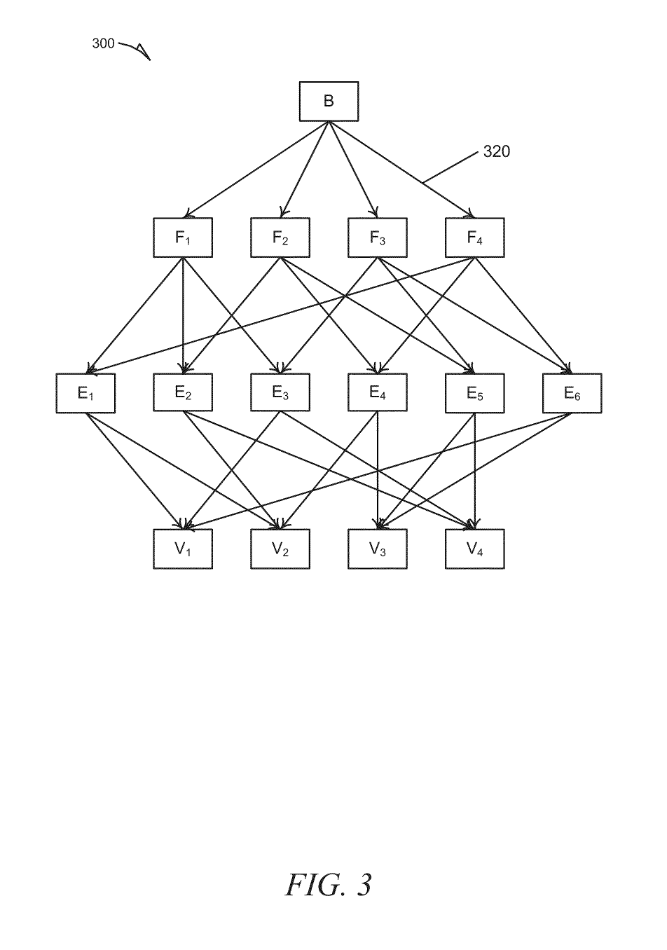

FIG. 3 illustrates an example semantic graph 300 of the BREP model 200. As may be seen in the semantic graph 300, the topological elements BREP model 200 (e.g., V₁-V₄) are represented as nodes (e.g., squares) and the hierarchical relationships between the topological elements (B→F₁-F₄) may be represented by links 320 between the nodes. Both the nodes and the links of the semantic graph 300 may be typed, that is each node may have a type (e.g., vertex or edge) and each link may have a type (e.g., inclusion). For example, a node of type “vertex” may include associated geometric information such as the spatial coordinates (x, y and z axis) of the vertex represented by the node. For example, a link of the type “inclusion” is a directed link (e.g., arrows) from one node representing a topological element, such as body B, to another node representing a topological element included in body B, for example, face F₁ or face F₂. The link type “inclusion” may also be referred to as “composed of” or “is formed by”, etc.

In an example, a general rule engine may query a repository of semantic graphs of manufacturing features with a semantic graph of a BREP in order to identify instances of manufacturing features. This identification process may be analogous to identifying a sub-graph in a larger graph, which is also known as sub-graph isomorphism. The recognized sub-graphs may then be utilized to map instances of manufacturing features to the corresponding semantic graph of the BREP. The numerical processor may then compute feature-specific geometric attributes of each of these instances. Using the same rule engine, the feature instances may then be flagged based on a comparison of their geometric attributes against a repository of semantic manufacturing rules.

### Example Operating Environment

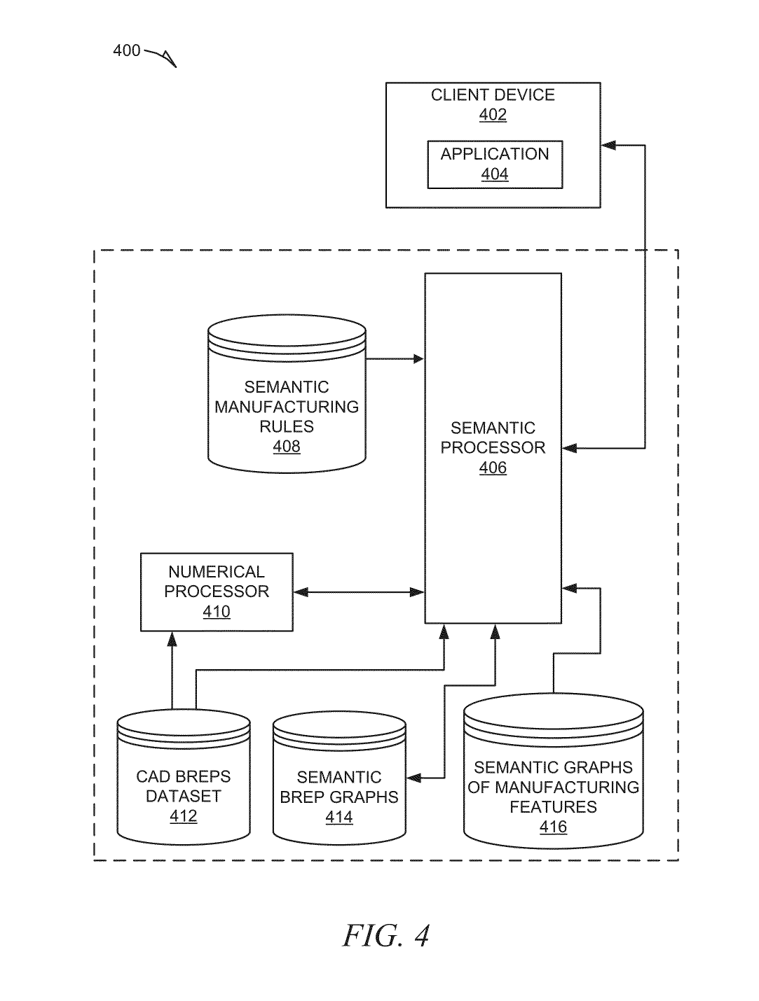

FIG. 4 is a block diagram illustrating an environment 400 for operating a system, according to an example embodiment, including a semantic processor 406. The environment 400 is an example environment within which methods and systems for identifying manufacturing features from CAD datasets may be performed for a CAD BREPs dataset 412. The environment 400 may include a client device 402 (e.g., processing device such as a desktop computer, laptop, tablet or smartphone), an application 404 (e.g., CAD application) running on the client device 402, and elements of a system for processing both CAD and semantic datasets. The elements may include a semantic processor 406, a numerical processor 410, and data stored in containers (e.g., databases or repositories). The data includes semantic manufacturing rules 408, a CAD BREPs dataset 412, semantic graphs of BREPs 414, and semantic graphs of manufacturing features 416. It will be appreciated that although the elements are shown individually, any of the individual elements may be combined into a single element for performing the functions of each of the combined elements.

In an example, the method for recognizing manufacturing features may incorporate multiple software paradigms: object-oriented, procedural and declarative. For example, the architecture may include Java, Web Ontology Language (OWL) (or Semantic Application Design Language (SADL), or the Jena open source Semantic Web framework for Java) and CAD (e.g., Siemens NX). The method may access, from an NX dataset, the elements of a BREP, both geometric (e.g., numerical) properties and topological properties. The method may then generate an OWL graph representation of the elements of the BREP. The method may use Java to control the logic of the method steps and also to bridge the CAD and the OWL data, since OWL and CAD APIs are not (currently) compatible.

The client device 402 may have multiple applications installed on it, including an application 404 for computer aided design. A user of client device 402 may design an item for manufacture using application 404 and the data related to this item may be included in a CAD BREPs dataset 412. In order to understand whether the item being designed may be manufactured (e.g., cost effectively), the user of client device 402 may request (through application 404) that the semantic processor 406 assist the user in identifying manufacturing features present in the item represented by the data in CAD BREPs dataset 412. A semantic processor 406 may use Java to query all BREP elements (bodies, faces, edges and vertices) from CAD BREPs dataset 412 and generate a java instance and an OWL instance for each element. The semantic processor 406 may also use Java to query geometric attributes from CAD BREPs dataset 412 and assign them as numerical properties of the OWL instances, for example, an aspect ratio. The types of geometric attributes to query will depend on the type of BREP element for which the geometric attributes are queried. The semantic processor 406 may then generate a corresponding semantic graph of each BREP from CAD BREPs dataset 412, based on the respective topological elements and geometric attributes, and store these corresponding semantic graphs in semantic BREP graphs 414. The semantic graphs may be provided using, for example, the Web Ontology Language (OWL), a semantic markup language based on the Resource Description Framework (RDF).

The numerical processor 410 may then compute relevant geometric attributes for elements (e.g., edge or face) of the BREPs of CAD BREPs dataset 412, for example, based on the numerical properties associated with the OWL instance for each element of the BREPs of CAD BREPs dataset 412. In an example, the numerical processor 410 may generate a concave/convex value for each of the edges of a BREP or may determine face adjacencies for each of the faces of a BREP. This computed geometric attribute data may be accessed by the semantic processor 406, which may then modify the corresponding semantic graph of each of the BREPs of CAD BREPs dataset 412 based on their respective computed geometric attribute data. For example, a node of a semantic graph representing an edge element might be modified to include a “concave” descriptor or a node representing a face element might be enhanced with face adjacency type information.

In an example, the semantic processor 406 may iteratively query the semantic graphs of manufacturing features 416 with the semantic graphs of each of the BREPs from CAD BREPs dataset 412 in order to identify instances of manufacturing features present in the item design associated with the BREPs of CAD BREPs dataset 412. The semantic processor 406 may, for example, accomplish the identifications via semantic inference processing and/or numerical processing.

In an example, the numerical processor 410 may then compute geometric attributes associated with instances of manufacturing features that have been identified. For example, if an instance of a “hole” manufacturing feature has been identified then the numerical processor 410 may compute a diameter or depth of the hole. The numerical processor 410 may perform the computations based on geometric attributes (e.g., numerical properties) associated with the semantic graphs of the BREPs from CAD BREPs dataset 412 or further geometric (numerical) attributes may be queried from the CAD BREPs dataset 412 for this purpose.

In an example, the semantic processor 406 may iteratively query a repository of manufacturing rules in semantic manufacturing rules 408 based on the corresponding semantic sub-graph (including any associated geometric attributes) of each instance of an identified manufacturing feature in order to identify instances of manufacturing features that do not comply with a specified manufacturing rule that is semantically described in semantic manufacturing rules 408. The semantic processor 406 may, for example, accomplish the identifications via semantic inference processing and/or numerical processing.

In an example, the semantic processor 406 may then present a user of application 404 on client device 402 with a display of the identified instances of manufacturing features (e.g., 133 in FIG. 1B) and any manufacturing rules (e.g., 132 in FIG. 1B) that the particular instance may checked against to determine if the instance is in compliance with said rules. In an example, the semantic processor 406 may present a user of application 404 on client device 402 with a highlighted element (e.g., 114 in FIG. 1A) within application 404 that corresponds to a manufacturing feature (e.g., “Bend” in FIG. 1B) that has been flagged as possibly not complying with at least one manufacturing rule. In an example, the semantic processor 406 may then present a user of application 404 on client device 402 with a field (e.g., 137 in FIG. 1B) in which the user may submit a semantic query regarding the identified conflict between the item design and the semantic manufacturing rules 408. In an example, the semantic processor 406 may then present a user of application 404 on client device 402 with a display including suggestions (e.g., in response to the query) for resolving the conflict between the design and the semantic manufacturing rules 408 based on further inferences from the semantic manufacturing rules 408.

In an example, the semantic manufacturing rules 408 may include data regarding manufacturing process capabilities, cost predictions (which may be fixed or parametric), expert recommendations, supplier information and dimensional limits (which may be fixed or parametric). In an example, the semantic manufacturing rules 408 and the semantic graphs of manufacturing features 416 may be easily updated by subject matter experts because the rules are similar to standard English language statements. In an example, both the semantic manufacturing features and semantic manufacturing rules may be semantically defined using Semantic Application Design Language (SADL). SADL allows executable models to be defined in an English-like natural language, making it easier to describe, communicate, and express these definitions and rules. This may result in reductions to the commercial overhead of training and developing expertise. In addition, the ability to author the model and rules independent of any particular commercial CAD application may allow for feature and rule descriptions that are agnostic to the CAD tool and also avoid any backward compatibility issues.

For example, the semantic manufacturing rules 408 may include the following:

Class Hole:
described by radius with a single value of type double, and described by height with a single value of type double.

Rule validateHole:
given hole1 is a Hole
if radius of hole1>=height of hole1
then hole1 is Flagged.

### Example Methods

Further methods will be described below by way of example; in particular the methods will be described in relation to the previously described example figures and elements.

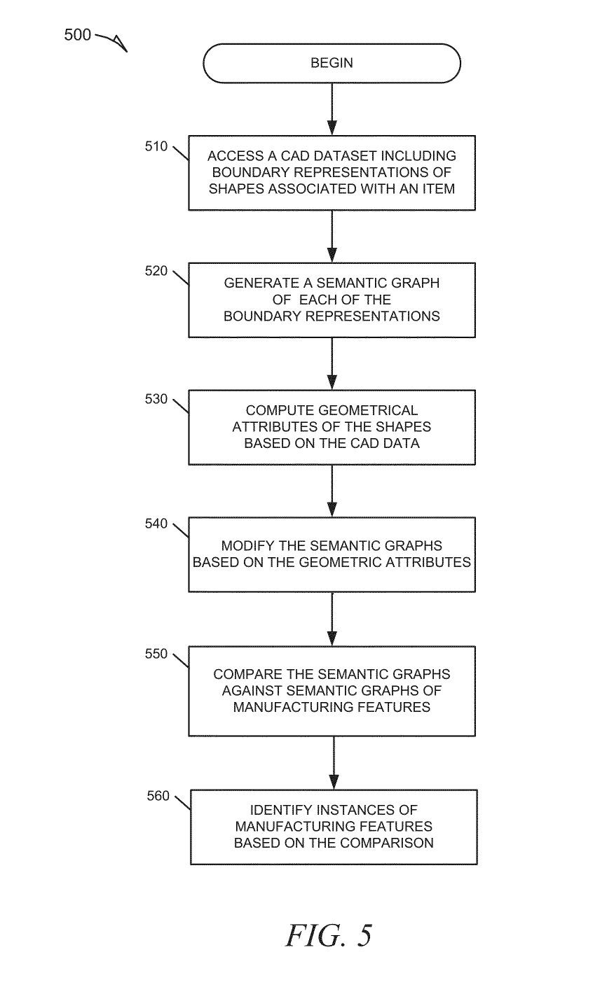

FIG. 5 is a flowchart illustrating a method 500, according to an example embodiment, for identifying instances of manufacturing features associated with an item being designed with a CAD application. In an example embodiment, the method 500 may include operations for: accessing a dataset including BREPs associated with an item at operation 510, generating a semantic graph of each of the BREPs at operation 520; computing geometric attributes of shapes based on the BREP data associated with the shape at operation 530; modifying the semantic graph of the BREP associated with each shape based on the corresponding computed geometric attributes at operation 540; comparing the semantic graphs of the BREPs against semantic graphs of manufacturing features at operation 550; and identifying instances of manufacturing features based on the comparison at operation 560.

In an example embodiment, the method 500 may begin at operation 510 with semantic processor 406 accessing information regarding an item for manufacture represented by, for example, the data in CAD BREPs dataset 412.

The method 500 may continue at operation 520 with the semantic processor 406 generating a semantic graph of each BREP included in CAD BREPs dataset 412 and storing the semantic graphs of the BREPs in semantic BREP graphs 414. In an example, the semantic processor 406 may recursively iterate over the bodies, faces, edges and vertices of the BREPs from CAD BREPs dataset 412 and generate an OWL instance of each topological element in order to generate corresponding semantic graphs for each of the BREPs of CAD BREPs dataset 412.

In an example, the semantic processor 406 may also include any geometric attributes associated with each topological element of the BREPs from the CAD BREPs dataset 412 as a numerical property of the corresponding OWL instance generated for each to the corresponding semantic graph for each of the topological element of the BREPs from the CAD BREPs dataset 412 such as, for example, an area or an aspect ratio.

The method 500 may continue at operation 530 with the numerical processor 410 computing relevant geometric attributes for each of the elements (e.g., topological elements) of each of the BREPs of CAD BREPs dataset 412. The numerical processor 410 may perform the computations based on geometric attributes (e.g., numerical properties) associated with the semantic graphs of the BREPs from CAD BREPs dataset 412 or further geometric (numerical) attributes may be queried from the CAD BREPs dataset 412 for this purpose.

The method 500 may continue at operation 540 with semantic processor 406 modifying the corresponding semantic graph of each of the BREPs of CAD BREPs dataset 412 based on their respective computed attribute data such as, for example, adding “concave” to the semantic graph instance of an edge (e.g., node).

The method 500 may continue at operation 550 with semantic processor 406 iteratively querying the semantic graphs of manufacturing features 416 with the corresponding semantic graphs for each of the BREPs (as modified based on any associated geometric attributes) from CAD BREPs dataset 412 so as to compare the semantic graphs of the BREPs to semantic graphs of manufacturing features 416.

The method 500 may continue at operation 560 with semantic processor 406 identifying (e.g., sub-graph recognition) instances of manufacturing features that may be present in an item design associated with the BREPs of CAD BREPs dataset 412 based on the comparison at operation 550.

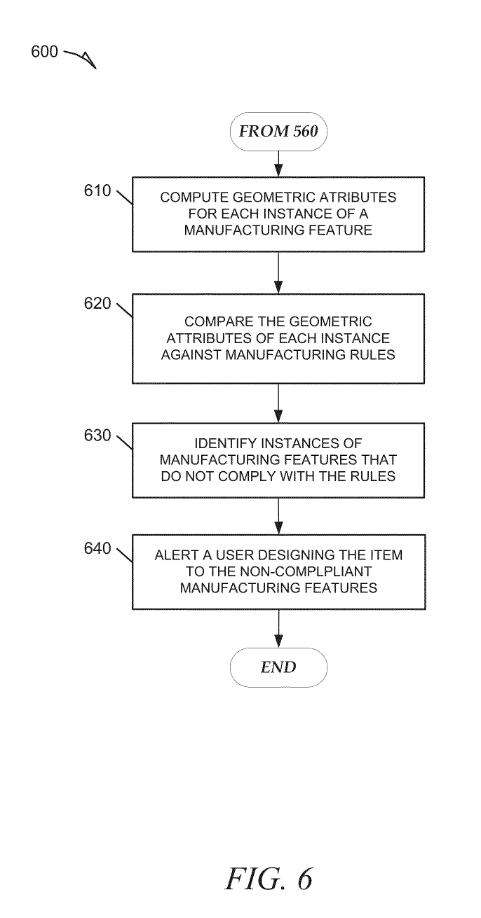

FIG. 6 is a flowchart illustrating a method 600 for comparing geometric attributes of identified instances of manufacturing features against a set of semantic manufacturing rules (e.g., in semantic manufacturing rules 408) according to an example embodiment. In an example, the method 600 may continue from the last operation of method 500 (operation 560) and include operations for: computing at least one geometric attribute for each instance of a manufacturing feature at operation 610; comparing the at least one geometric attribute against semantic manufacturing rules at operation 620, identifying instances of manufacturing features that do not comply with the rules based on the comparison at operation 630; and alerting a user designing the item to the instance of a non-compliant manufacturing feature at operation 640.

In an example, the method 600 may begin at operation 610 with a numerical processor 410 computing relevant geometric attributes associated with instances of manufacturing features that have been identified. Since the manufacturing features are not recognized, as such, in CAD BREPs dataset 412 the geometric attributes of the features may not be queried from the CAD BREPs dataset 412 and should instead be computed. For example, if an instance of the manufacturing feature “hole” has been identified, then the numerical processor 410 may compute a “diameter” or “depth” of the hole as the at least one geometric attribute. The numerical processor 410 may, for example, accomplish the computations based on numerical properties associated with the semantic sub-graph corresponding to the identified instance of a manufacturing feature.

The method 600 may continue at operation 620 with the semantic processor 406 iteratively querying the semantic manufacturing rules 408 based on the computed geometric attributes for each instance of an identified manufacturing feature so as to compare the geometric attributes of each feature to suggested limits for such attributes in an item of the type that is being designed. For example, the geometric attributes of an item type: “Sheet Metal” may be compared against the semantic manufacturing rules 408 for sheet metal items. For example, the semantic manufacturing rules 408 may include the semantic description: “flag any triangle with an interior angle smaller than 5 degree because our tool is not able to make it”.

The method 600 may continue at operation 630 with the semantic processor 406 identifying instances of manufacturing features that may not comply with a specified manufacturing rule that is semantically described in semantic manufacturing rules 408 based on the comparison. The semantic processor 406 may, for example, accomplish the identifications via semantic inference processing and/or numerical processing.

The method 600 may continue at operation 640 with the semantic processor 406 presenting a user of application 404 on client device 402 (designing an item associated with CAD BREPs dataset 412) with a display of the identified instances of manufacturing features and any manufacturing rules that the particular instance may checked against. The semantic processor 406 may present a user of application 404 on client device 402 with a highlighted element (e.g., 114 in FIG. 1A) within application 404 that corresponds to a manufacturing feature (e.g., “Bend” in FIG. 1B) that has been flagged as possibly not complying with at least one manufacturing rule. The semantic processor 406 may then present a user of application 404 on client device 402 with a field (e.g., 137 in FIG. 1B) in which the user may submit a semantic query regarding the identified conflict between the item design and the semantic manufacturing rules 408. The semantic processor 406 may then present a user of application 404 on client device 402 with a display including suggestions (e.g., in response to the query) for resolving the conflict between the design and the semantic manufacturing rules 408 based on further inferences from the semantic manufacturing rules 408.

### Modules, Components And Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time concerns.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of these. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry (e.g., a FPGA or an ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures may be considered. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures deployed, in example embodiments.

### Example Architecture and Machine-Readable Medium

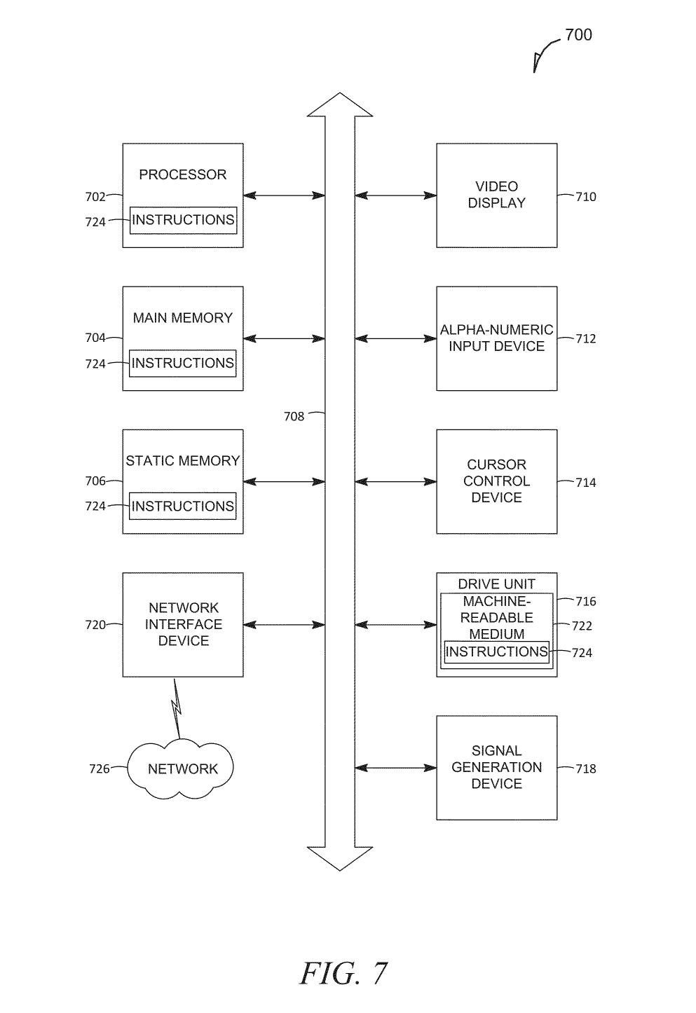

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal displays (LCD) or a cathode ray tube (CRT)). The computer system 700 also includes an alphanumeric input device 712 (e.g., a keyboard), a cursor control (user interface (UI) navigation) device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of data structures and instructions 724 (e.g., software) embodying or used by any one or more of the methodologies or functions described herein. The instructions 724 may also reside, completely or at least partially, within the main memory 704, static memory 706, and/or within the processor 702 during execution thereof by the computer system 700, with the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions (e.g., instructions 724) for execution by the machine and that cause the machine to perform any one or more of the methodologies disclosed herein, or that is capable of storing, encoding or carrying data structures used by or associated with such instructions. The term “machine-readable medium” shall accordingly be taken to include, but not be limited to, solid-state memories and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although the present disclosure includes references to specific example embodiments, it will be evident that various modifications and changes may be made to these embodiments without departing from the broader spirit and scope of the present disclosure. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of embodiments including combinations of the embodiments, and embodiments not specifically described.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes: “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels, and are not intended to impose numerical requirements on objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. The claims are hereby incorporated into the Detailed Description, with each claim describing a separate embodiment.

1. A method comprising:
accessing a computer aided design (CAD) dataset by a semantic processing module including at least one hardware processor, the dataset representing an item to be manufactured and including boundary representations of shapes and numerical data associated with the boundary representations;
generating, by the semantic processing module for each of the boundary representations, a semantic graph of the boundary representation;
computing, by a numerical processing module including at least one hardware processor, at least one geometric attribute of each of the shapes based on the numerical data associated with the boundary representations;
modifying, by the semantic processing module, the semantic graph of the boundary representation of each shape based on the at least one geometric attribute of the shape; and
comparing, by the semantic processing module, each of the semantic graphs of boundary representations against a repository of semantic graphs of manufacturing features to identify instances of manufacturing features.

2. The method of claim 1, further comprising:
computing, by the numerical processing module for each instance of a manufacturing feature, at least one geometric attribute associated with the instance based on the numerical data associated with the boundary representations.

3. The method of claim 2, further comprising:
comparing, by the semantic processing module for each instance of a manufacturing feature, the at least one geometric attribute associated with the instance against a repository of semantic graphs of manufacturing rules to determine that at least one instance of the manufacturing feature is not in compliance with the manufacturing rules.

4. The method of claim 3, further comprising:
alerting a user designing the item of the presence of the at least one instance of the manufacturing feature that is not in compliance with the manufacturing rules.

5. The method of claim 3, wherein:
each of the boundary representations of the dataset includes at least one vertex, edge, face or body; and
each semantic graph of a boundary representation includes topological and geometric attributes associated with each of the at least one vertex, edge, face or body.

6. The method of claim 5, wherein computing the at least one geometric attribute of each of the shapes includes determining that two faces in a boundary representation of the shape are adjacent to each other or determining that an edge in a boundary representation of the shape is concave.

7. The method of claim 5, further comprising:
generating a semantic graph of each of the boundary representations by generating nodes for each of the at least one vertex, edge, face or body and by generating links between each of the nodes for the topological relationships between the at least one vertex, edge, face or body; wherein each node has a set of topological and geometric attributes associated with it.

8. A system comprising:
a semantic processing module including at least one processor and configured to:
access a computer aided design (CAD) dataset representing an item to be manufactured and including boundary representations of shapes and numerical data associated with the boundary representations;
generate, for each of the boundary representations, a semantic graph of the boundary representation; and
a numerical processing module including at least one processor and configured to:
compute at least one geometric attribute of each of the shapes based on the numerical data associated with the boundary representations.

9. The system of claim 8, wherein the semantic processing module is further configured to:
modify the semantic graph of the boundary representation of each shape based on the at least one geometric attribute of the shape; and
compare each of the semantic graphs of boundary representations against a repository of semantic graphs of manufacturing features to identify instances of manufacturing features.

10. The system of claim 9, wherein the numerical processing module is further configured to:
compute, for each instance of a manufacturing feature, at least one geometric attribute associated with the instance based on the numerical data associated with the boundary representations.

11. The system of claim 10, wherein the semantic processing module is further configured to:
compare, for each instance of a manufacturing feature, the at least one geometric attribute associated with the instance against a repository of semantic graphs of manufacturing rules to determine that at least one instance of the manufacturing feature is not in compliance with the manufacturing rules.

12. The system of claim 11, wherein the semantic processing module is further configured to:
alert a user designing the item of the presence of the at least one instance of the manufacturing feature that is not in compliance with the manufacturing rules..

13. The system of claim 12, wherein:
each of the boundary representations of the dataset includes at least one vertex, edge, face or body; and
each semantic graph of a boundary representation includes topological and geometric attributes associated with each of the at least one vertex, edge, face or body.

14. The system of claim 13, wherein the semantic processing module is further configured to:
generate a semantic graph of each of the boundary representations by generating nodes for each of the at least one vertex, edge, face or body and by generating links between each of the nodes for the topological relationships between the at least one vertex, edge, face or body; wherein each node has a set of topological and geometric attributes associated with it.

15. A non-transitory machine-readable storage medium including instructions that, when executed on at least one processor of a machine, cause the machine to perform operations comprising:
accessing a computer aided design (CAD) dataset by a semantic processing module including at least one hardware processor, the dataset representing an item to be manufactured and including boundary representations of shapes and numerical data associated with the boundary representations;
generating, by the semantic processing module for each of the boundary representations, a semantic graph of the boundary representation;
computing, by a numerical processing module including at least one hardware processor, at least one geometric attribute of each of the shapes based on the numerical data associated with the boundary representations;
modifying, by the semantic processing module, the semantic graph of the boundary representation of each shape based on the at least one geometric attribute of the shape; and
comparing, by the semantic processing module, each of the semantic graphs of boundary representations against a repository of semantic graphs of manufacturing features to identify instances of manufacturing features.

16. The non-transitory machine-readable storage medium of claim 15, wherein the operations further comprise:
computing, by the numerical processing module for each instance of a manufacturing feature, at least one geometric attribute associated with the instance based on the numerical data associated with the boundary representations.

17. The non-transitory machine-readable storage medium of claim 16, wherein the operations further comprise:
comparing, by the semantic processing module for each instance of a manufacturing feature, the at least one geometric attribute associated with the instance against a repository of semantic graphs of manufacturing rules to determine that at least one instance of the manufacturing feature is not in compliance with the manufacturing rules.

18. The non-transitory machine-readable storage medium of claim 17, wherein the operations further comprise:
alerting a user designing the item of the presence of the at least one instance of the manufacturing feature that is not in compliance with the manufacturing rules.

19. The non-transitory machine-readable storage medium of claim 17, wherein:
each of the boundary representations of the dataset includes at least one vertex, edge, face or body; and
each semantic graph of a boundary representation includes topological and geometric attributes associated with each of the at least one vertex, edge, face or body.

20. The non-transitory machine-readable storage medium of claim 19, wherein the operations further comprise:
generating a semantic graph of each of the boundary representations by generating nodes for each of the at least one vertex, edge, face or body and by generating links between each of the nodes for the topological relationships between the at least one vertex, edge, face or body; wherein each node has a set of topological and geometric attributes associated with it.
